(19) United States
(12) Patent Application Publication
(10) Pub. No.: US 2008/0199124 A1
(43) Pub. Date: Aug. 21, 2008

(54) OPTICAL DEVICE FOR GENERATING AND MODULATING THz AND OTHER HIGH FREQUENCY SIGNALS

(76) Inventors: Tadao Nagatsuma, Tokyo (JP); Yuichi Kado, Tokyo (JP); Richard Ridgway, Westerville, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/381,618

(22) Filed: May 4, 2006

Related U.S. Application Data
(60) Provisional application No. 60/712,108, filed on Aug. 29, 2005.

(51) Int. Cl. G02F 1/295

(52) U.S. Cl. 385/8

(57) ABSTRACT

Optical generation and modulation is carried out in the optical domain and converted to, for example, the THz band using suitable optical/electrical conversion hardware. In accordance with one embodiment of the present invention, an electrooptic modulator is significantly overdriven to create sidebands on an optical carrier signal. An arrayed waveguide grating or other suitable filter is then used to filter the optical signal and remove the carrier signal and unwanted sidebands. The desired sidebands are then combined to create an optical signal that can be encoded with data through suitable modulation. Additional embodiments are disclosed.

### CROSS-REFERENCE TO RELATED APPLICATIONS

This application claims the benefit of U.S. Provisional Application Ser. No. 60/712,108 (OPI 0022 MA), filed Aug. 29, 2005.

### BACKGROUND OF THE INVENTION

The present invention relates to optical devices and, more specifically, to optical devices configured to generate high frequency optical signals that may be encoded with data and converted to an electrical data signal.

Generally, and by way of illustration, not limitation, there is a growing interest in the generation and modulation of high frequency signals. For example, the present inventors have contemplated that signals in the THz spectrum (0.1 to 10 THz) may find significant utility in imaging and wireless applications. For imaging, the THz spectrum may provide high resolution imaging through walls, cargo containers, and other visible barriers. It is contemplated that modulation onto these high frequency signals can provide improved resolution and the ability to separate a desired target from clutter. For wireless data communications, it is contemplated that the THz spectrum may allow ultra high data transfer (10 GB/s) for transmission of uncompressed high definition television channels. However, significant design challenges face those who endeavor to design systems for the generation and modulation of coherent THz and other high frequency signals.

### BRIEF SUMMARY OF THE INVENTION

According to the present invention, generation and modulation is carried out in the optical domain and converted to, for example, the THz band using suitable optical/electrical conversion hardware. In accordance with one embodiment of the present invention, an electrooptic modulator is significantly overdriven to create sidebands on an optical carrier signal. An arrayed waveguide grating or other suitable filter is then used to filter the optical signal and remove the carrier signal and unwanted sidebands. The desired sidebands are then combined to create an optical signal that can be encoded with data through suitable modulation.

In accordance with another embodiment of the present invention, an integrated optical circuit is provided that combines a sideband generator and an arrayed waveguide grating integrated on a common silicon substrate. The integration of these two components onto a single silicon substrate allows the realization of a small, integrated THz generator/modulator chip. Accordingly, it is noted that the scope of the present invention extends to general device configurations and is not necessarily limited to overdriven electrooptic modulators.

In accordance with yet another embodiment of the present invention, an optical device is provided where the sideband generator comprises an electrooptic interferometer comprising first and second waveguide arms and a modulation controller configured to drive the sideband generator at a control voltage substantially larger than V_{π}, where V_{π} represents the voltage at which a π phase shift is induced between respective arms of the interferometer. In this manner, the sideband generator can be driven to generate frequency sidebands about a carrier frequency of the optical signal. The optical filter discriminates between the frequency sidebands and the carrier frequency such that the sidebands of interest can be directed to the optical output.

The sideband generator can be configured such that the carrier frequency of the optical signal is dominated by odd or even harmonic frequency sidebands of the carrier frequency. The odd or even harmonic frequency sidebands typically comprise third or higher order odd or even harmonic frequency sidebands of the carrier frequency and the control signal can be selected such that it approximates a sinusoidal voltage where the amplitude of the third or greater order sidebands reaches a maximum. Where the sideband generator is configured as an electrooptic interferometer, the sideband generator can comprise as a modulation controller configured to drive the sideband generator at a control voltage of at least about 2Vπ.

Accordingly, it is an object of the present invention to provide an improved optical device for the generation and modulation of high frequency optical signals. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is a schematic illustration of an optical device according to one embodiment of the present invention;

FIG. 2 is a schematic illustration of an optical device according to the present invention in the context of a planar lightwave circuit;

FIGS. 3A-3D are graphic illustrations of the time-domain response of a sideband generator according to one embodiment of the present invention with drive voltage amplitudes equal to V_{π}/4, V_{π}/2, V_{π},and 2V_{πpl ;}

FIG. 4 is a graphic illustration of the relationship between the amplitude of the odd numbered harmonics and the normalized drive voltage, Vₘ/V_{π} in the context of a sideband generator according to one embodiment of the present invention;

FIGS. 5A-5C are graphic illustrations of an unmodulated optical signal and an optical spectrum at the output of a sideband generator according to the present invention with Vₘ=Vπ and Vₘ=2Vπ;

FIG. 6 is a schematic illustration of the operation of an optical filter and signal combiner according to one embodiment of the present invention;

FIG. 7 is a schematic illustration of the operation of data encoder according to one embodiment of the present invention;

FIGS. 8A-8D are graphic illustrations of the time-domain response of a sideband generator according to another embodiment of the present invention with drive voltage amplitudes equal to V_{π}/4, V_{π}2, V_{π}, and 2V_{π;}

FIG. 9 is a graphic illustration of the relationship between the amplitude of the even numbered harmonics and the normalized drive voltage, Vₘ/V_{π} in the context of a sideband generator according to one embodiment of the present invention;

FIG. 10 is a schematic illustration of a phase modulator configuration according to an embodiment of the present invention where a phase modulator is used as a sideband generator; and

FIGS. 11A-11D are graphic illustrations of an optical spectrum at the output of a phase modulator sideband generator according to the present invention with Vₘ=0.01Vπ, Vₘ=0.50Vπ, Vₘ=Vπ, and Vₘ=2.04Vπ.

### DETAILED DESCRIPTION

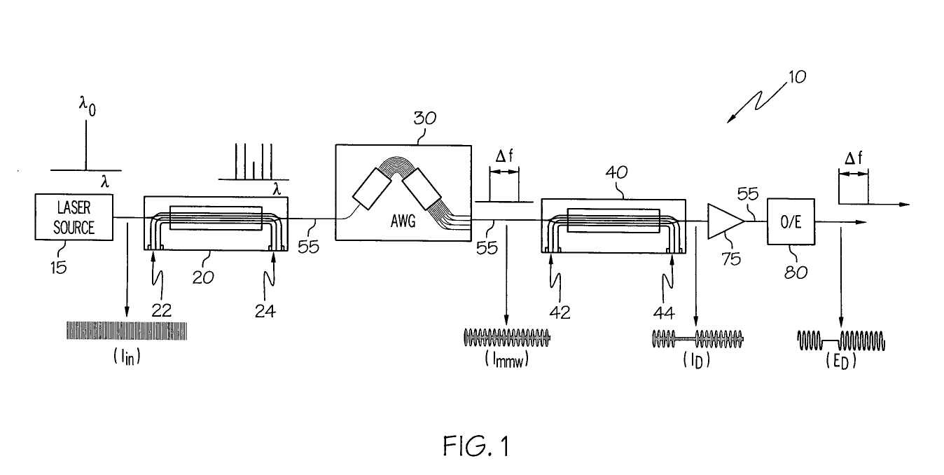

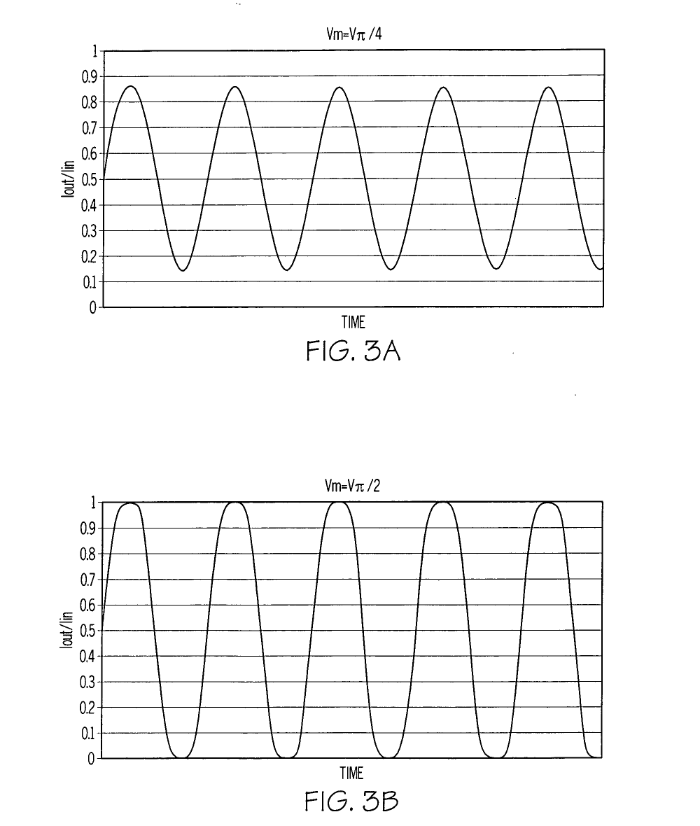

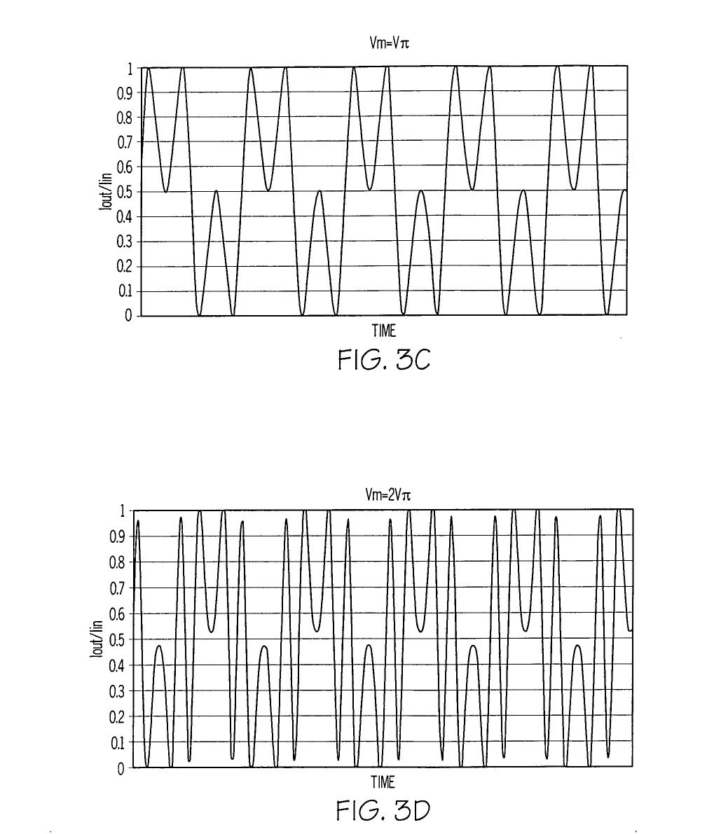

Referring initially to FIG. 1, an optical device 10 according to one embodiment of the present invention is illustrated. Generally, the illustrated optical device 10 comprises, among other things, a sideband generator 20, an optical filter 30, and a waveguide network 55 configured to direct an optical signal from an optical input 12 of the optical device 10 through the sideband generator 20 and the optical filter 30 to an optical output 14 of the optical device 10. As will be discussed in greater detail with reference to FIGS. 3-5 below, the sideband generator 20 is configured to generate frequency sidebands S about a carrier frequency λ₀ of the input optical signal I_{IN}. The optical filter 30 is configured to discriminate between the frequency sidebands S and the carrier frequency λ₀ so as to direct particular sidebands of interest to the optical output 14 in the form of a millimeter wave optical signal I_{MMW}. Where data-encoded modulation of the output signal is desired, the optical device 10 further comprises a data encoder 40 configured generate an encoded optical data signal I_{D}

The sideband generator 20 can be configured as an electrooptic interferometer. More specifically as a Mach-Zehnder interferometer where an optical signals propagating in the input segment of the interferometer is divided into two equal parts at, e.g., a Y-splitter. The two optical signals propagate down the two arms of the interferometer before being recombined with, e.g, a Y-combiner. If the two optical signals are in phase at the Y-combiner, the signals constructively interfere and the full intensity propagates out the output waveguide. If, however, the two optical signals are out of phase, then the signals destructively interfere and the output intensity is reduced. If the signals at the Y-combiner are out of phase by π radians, then the two signals will destructively interfere and the output will be at a minimum.

For an electrooptically-controlled Mach-Zehnder interferometer, for example, a 12 GHz voltage applied to the electrooptic waveguides via, a modulation signal input terminal 22 and a 50Ω control signal termination 24, will induce a phase shift that will adjust the constructive and destructive interference at the signal combiner. When the voltage applied to the electrooptic waveguides induces a π phase shift between the two arms, the output will be minimized. The voltage that induces the π phase is known as Vπ. By way of illustration and not limitation, specific teachings on some suitable control electrode and waveguide configurations for use in the sideband generator 20 and data encoder 40 of the present invention are presented in U.S. PG Pub. Nos. 2005/0226547 A1 for Electrooptic Modulator Employing DC Coupled Electrodes and 2004/0184694 A1 for Electrooptic Modulators and Waveguide Devices Incorporating the Same.

When the electrooptic interferometer is biased at −π/2 and is modulated at a frequency of ƒₘ (note: ωₘ=2πƒₘ), then the magnitude of the output optical signal at the fundamental frequency and at each of the odd harmonics (i.e. 3ωₘ, 5ωₘ, . . . ) can be calculated using Bessel functions. Table 1 summarizes the magnitude of the fundamental and odd harmonics.

| Drive Voltage | Peak-to-Peak | Amplitude of Harmonic | | | |
|---|---|---|---|---|---|
| (Vₘ) | Voltage | ωₘ | 3ωₘ | 5ωₘ | 7ωₘ |
| V_{π}/4 | V_{π}/2 | 0.363 | 0.009 | 7.5e−5 | 2.8e−7 |
| V_{π}/2 | V_{π} | 0.567 | 0.069 | 0.0022 | 3.4e−5 |
| V_{π} | 2 V_{π} | 0.285 | 0.333 | 0.052 | 0.003 |
| 2 V_{π} | 4 V_{π} | −0.212 | 0.029 | 0.373 | 0.157 |

From Table 1, we can see that if the modulator is driven with a voltage less than V_{π}, then the amplitude of the harmonics is quite low. However, as the modulator gets driven harder, the magnitude of the harmonics becomes larger than the fundamental. FIGS. 3A-3D show the time-domain response of the interferometer with drive voltage amplitudes equal to V_{π}/4, V_{π}/2, V_{π}, and 2V_{π}. The odd harmonic 3ωₘ dominates the carrier frequency ωₘ in FIG. 3C. In FIG. 3D, the odd harmonic 5ωₘ dominates the carrier frequency ωₘ.

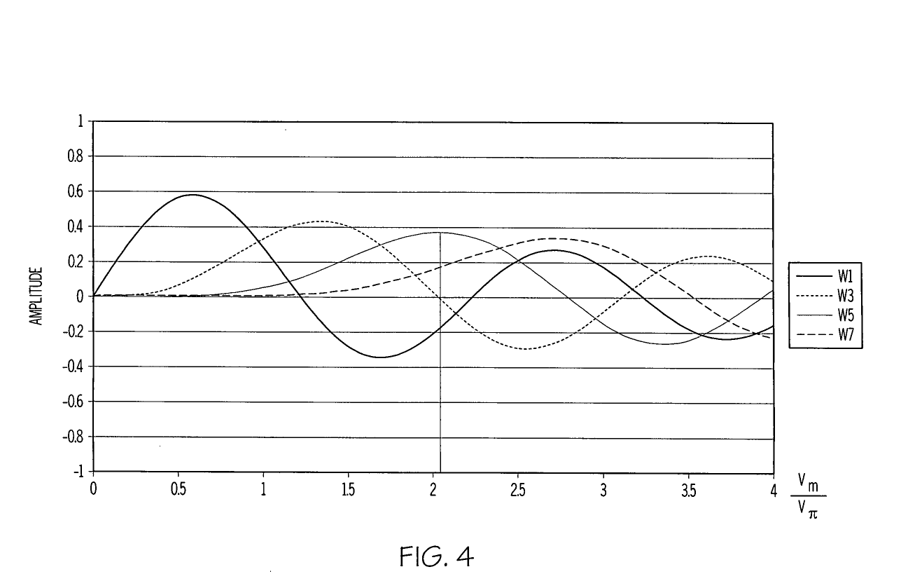

FIG. 4 graphically shows the relationship between the amplitude of the fundamental, third, fifth, and seventh harmonics and the normalized drive voltage, Vₘ/N_{π}. As can be seen from FIG. 4, if the electrooptic modulator functioning as the sideband generator 20 is driven with a voltage amplitude a little larger than 2V_{π}, then the amplitude of the fifth harmonic (W5) will be maximum. Regardless of which sideband is selected as the sideband of interest, it is contemplated that the control signal can be selected such that it approximates a sinusoidal voltage where the amplitude of the sideband of interest reaches a maximum.

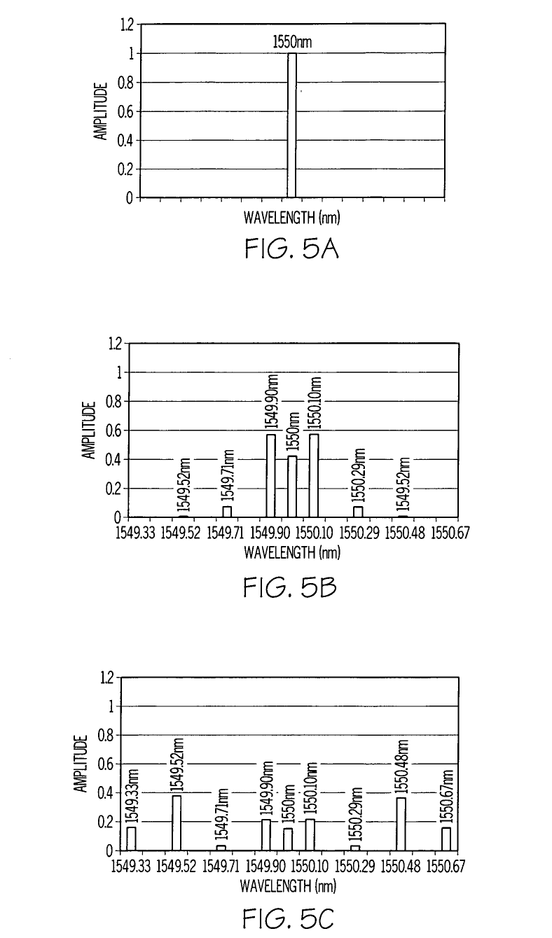

Referring to FIGS. 5A-5C, given the example where a 1550 nm optical signal is modulated at 10 GHz, the fundamental modulation frequency and any harmonics will be present as sidebands on the optical carrier at +/−0.08 nm from the 1550 nm carrier. FIG. 5A shows an unmodulated optical signal. FIG. 5B shows the optical spectrum at the output of the sideband generator 20 with Vₘ=Vπ. FIG. 5C shows the spectrum with Vₘ=2Vπ. The optical spectrum in FIG. 5C shows dominant sidebands at 1549.52 nm and 1550.48 nm. In the frequency domain, these wavelengths correspond to 193,608.4 GHz and 193,488.4 GHz, respectively. The difference between these two frequencies is 120 GHz. Again, this corresponds to +/− the fifth harmonic of the 12 GHz modulation frequency (i.e. +/−5*12 GHz or +/−60 GHz).

It is contemplated that the sidebands of interest need not dominate the optical signal output from the sideband generator 20. Rather, in many embodiments of the present invention, it may be sufficient to merely ensure that the magnitude of the frequency sidebands of interest, at an output of the sideband generator, is at least about 10% of a magnitude of the optical carrier signal at the optical input of the optical device.

Regarding the optical filter 30, as is noted above, the purpose of the optical filter 30 is to select the desired sidebands and remove the carrier frequency and any unwanted sidebands. This optical filtering function can be accomplished using a variety of technologies, including Bragg grating reflective filters, wavelength-selective Mach-Zehnder filters, multilayer thin film optical filters, arrayed waveguide gratings (AWG), micro ring resonator filters, and directional coupler filters that are wavelength selective. An arrayed waveguide grating is particularly useful because it is an integrated optical device with multiple channels characterized by very narrow bandwidths. The following discussion focuses on the use of an AWG, although other filters can also be used in accordance with the present invention.

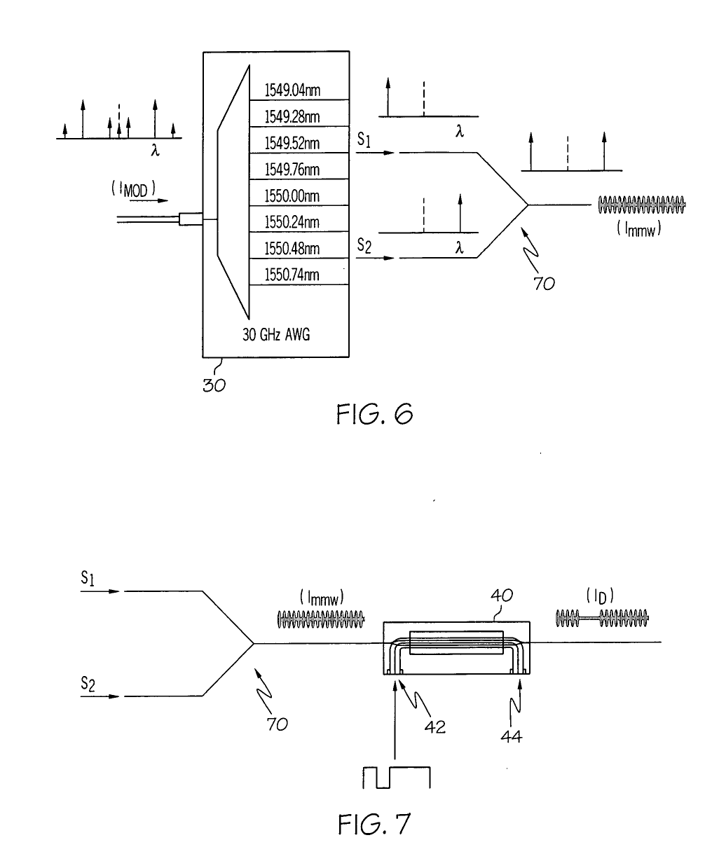

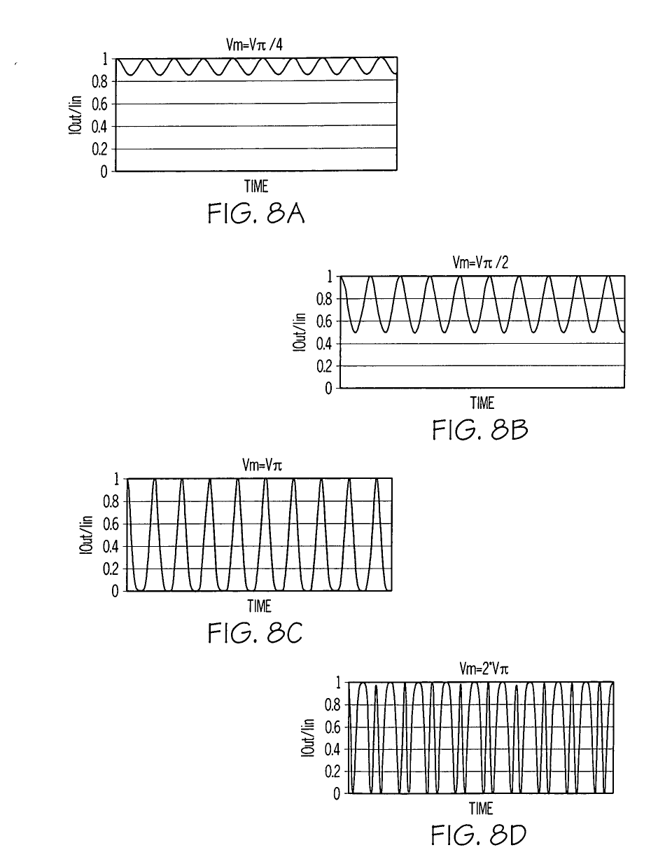

The role of the AWG is to filter out the undesirable sidebands and, with the cooperation of a signal combiner, combine the two sidebands of interest. For example, an AWG with a channel spacing of 60 GHz (Δλ=0.48 nm) or a channel spacing of 30 GHz (Δλ=0.24 nm) would be well-suited for the 120 GHz system described above. As is illustrated schematically in FIG. 6, where sideband wavelengths generated from the sideband generator as a modulated optical signal I_{MOD} are fed into the optical filter 30, each of the sidebands will come out a separate output channel of the filter 30 according to its characteristic wavelength. By way of illustration, not limitation, if the output of the sideband generator 20 is inserted into the AWG, then the two desired 5^{th} order harmonics would come out of ports 3 and 7, as shown schematically in FIG. 6. If, however, a 60 GHz AWG is used, the desired 5^{th} order sidebands would come out less displaced but still distinct ports, i.e., ports 4 and 6. One advantage of the 30 GHz AWG is that the port bandwidths are much narrower. However, 30 GHz AWGs are often more difficult to produce and operate. For these reasons, it may be preferable to operate some embodiments of the present invention by utilizing a 60 GHz AWG as the optical filter 30.

A signal combiner 70 according to the present invention is also illustrated in FIG. 6, where the desired sidebands are combined with a waveguide Y-combiner. For example, if two fifth harmonic sidebands are combined at the signal combiner 70, the optical signal I_{MMW} will have a continuous-wave modulation of 120 GHz. It is contemplated that a signal combiner would not be necessary where the optical filter comprises an optical device that is configured to maintain propagation of the sidebands of interest along a unitary optical path.

Referring to FIG. 7, once the modulated optical signal I_{MMW} is formed, data can be incorporated on the carrier by utilizing, for example, a 10 GB/s electrical data signal coupled to the data encoder 40 via the data signal input terminal 42 and the 50Ω control signal termination 44. Since it is generally easier to modulate an optical signal than to modulate a THz signal, data is encoded onto the signal I_{MMW} in the optical domain. Here a simple modulator configured as a Mach-Zehnder interferometer is used to encode the data. It is contemplated that alternative means may be employed to modulate the optical signal I_{MMW} in the optical or electrical domain without departing from the scope of the present invention.

Once the data is encoded onto the modulated optical signal, the composite signal I_{D} can be amplified and then converted to the THz portion of the spectrum. The optical amplification is relatively straight forward. Optical amplifiers, such as Erbium-doped fiber amplifiers will increase optical power without excessive loss of data modulation on the optical signal.

By way of illustration and not limitation, in one mode of operation, a standard telecommunications-grade laser diode 15 operating in the continuous-wave (CW) mode at a bandwidth centered at about 1550 nm provides the optical carrier frequency λ₀ used in the optical portion of the device 10. An electrooptic modulator functions as the sideband generator 20 and is overdriven in the manner described below such that the resulting optical signal includes a plurality of sidebands S on the optical carrier λ₀. For example, an appropriately configured modulator overdriven at twice Vπ, where Vπ represents the voltage at which a π phase shift is induced between respective arms of the modulator, will generate sidebands of interest at 5 times the modulation frequency. Accordingly, overdriving the modulator at 12 GHz will generate sidebands of interest about the 1550 nm optical carrier at +/−60 GHz.

A telecommunications-grade arrayed waveguide grating (AWG) with 60 GHz channels can be used as the optical filter 30 to filter out the carrier optical signal λ₀ and combine the two optical sidebands of interest, forming the millimeter wave optical signal modulated at 120 GHz. A second electrooptic modulator is used as the data encoder 40 to encode data onto the mmw-modulated optical signal and generate a data-encoded signal I_{D}. A telecommunications grade optical modulator using the electrooptic effect to control the phase in a Mach-Zehnder interferometer can encode data at 10 GB/s or higher.

An optical amplifier 75 increases the modulated optical signal I_{D} prior to conversion in a suitable optical/electrical converter 80. A high speed photodiode, tuned to operate at 0.12 THz can be used to remove the optical carrier and convert the signal I_{D} to a modulated THz signal E_{D}.

Although many embodiments of the present invention are illustrated herein with reference to optical signal splitters and combiners in the form of directional coupling regions, it is noted that the present invention contemplates utilization of any suitable conventional or yet to be developed structure for optical signal splitting or combining. For example, suitable alternative structures for splitting and combining optical signals include, but are not limited to, 2×2 directional coupling regions, 1×2 directional coupling regions, 1×2 Y signal splitters and combiners, and 1×2 and 2×2 multimode interference element splitters and combiners. The specific design parameters of these structures are beyond the scope of the present invention and may be gleaned from existing or yet to be developed sources, including U.S. Pat. No. 6,853,758, issued Feb. 8, 2005, the disclosure of which is incorporated herein by reference.

Up to this point, the present discussion has assumed that the initial Mach-Zehnder was biased with a phase difference in the two arms of V_{π}/2. However, if the modulator is biased so that the phase difference is equal to π (or a multiple of π), then the output optical signal will have even harmonics (2ω, 4ω, 6ω, . . . ) of the modulation signal. If the sideband generator 20 is driven with a voltage less than V_{π}, then the amplitude of the harmonics will be relatively low. However, as the sideband generator 20 gets driven harder, the magnitude of the harmonics becomes larger than the fundamental carrier frequency. FIGS. 8A-8D show the time-domain response of the sideband generator 20 with drive voltage amplitudes equal to V_{π}/4, V_{π}/2, V_{π}, and 2V_{π}. It should be noted that for this bias configuration, there is no modulation at the fundamental frequency. Instead, the 2^{nd} harmonic begins to grow immediately.

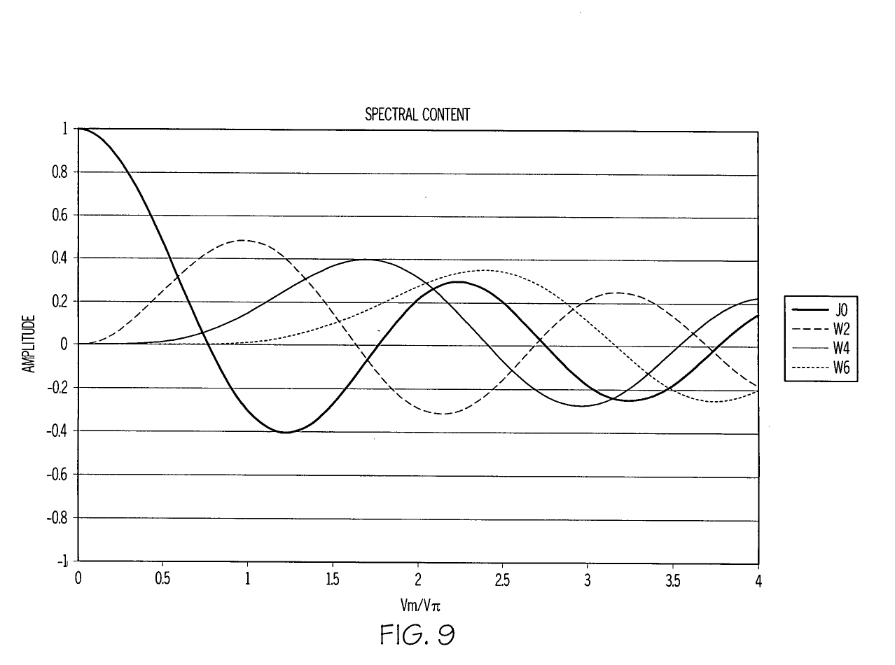

FIG. 9 is a graphic representation of the amplitude of the even harmonics, as a function of drive voltage. The graph shows the amplitude of the second harmonic (W2), the fourth harmonic (W4), and the sixth harmonic (W6). The data for J0 corresponds to a relative optical bias of the optical signal. Using the analysis developed earlier, this π bias configuration could be used to form sidebands at two four, and six times the modulation frequency. If we assume a drive frequency of 12 GHz, this bias method could be used to produce optical signals with CW-modulation at 96 GHz (+/− the fourth harmonic) and 144 GHz (+/− the sixth harmonic).

It is contemplated that the drive frequency need not be fixed at a particular value. Specifically, if the 12 GHz modulation control signal is instead provided as a variable frequency source, the frequency of the THz-band signal can also be variable. For example, if the 12 GHz control signal is changed to 12.5 GHz, then the difference of the fifth harmonics will change form 120 GHz to 125 GHz. Of course, any change in the frequency of the harmonics may necessitate a change in the operational parameters of the filter 30 because the new sidebands of interest will need to make it through the filter 30. In a similar way, adding optical switches between the optical filters and the Y-combiner will allow various sidebands to be combined. This can provide flexibility in obtaining a range of continuous wave modulated optical signals.

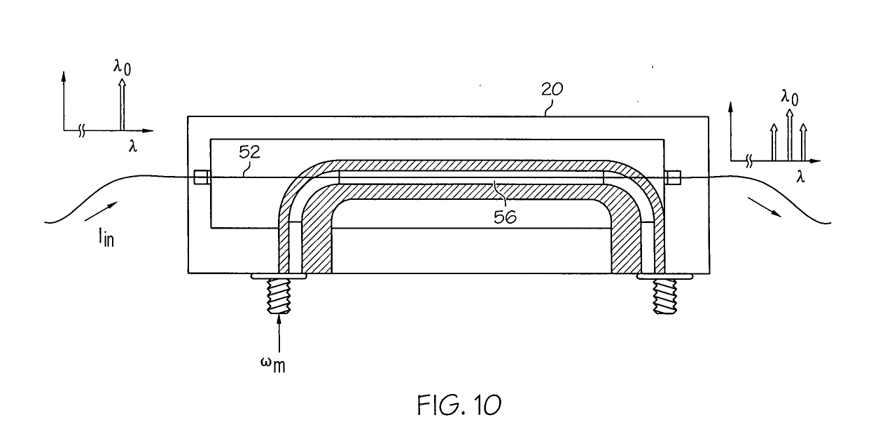

Referring to FIG. 10, it is further contemplated that the sideband generator 20 may take the form of a phase modulator, as opposed to the interferometer described above with reference to FIGS. 1-9. FIG. 10 is a schematic illustration of a suitable phase modulator configuration according to this aspect of the present invention. Generally, the phase modulator sideband generator 20 consists of a straight waveguide 52 with an electrooptic core and/or cladding configured such that, when an electric field is applied across an electrooptically functional portion 56 of the sideband generator 20, the refractive index in the waveguide 52 will change, which in turn will advance or retard the phase of the optical signal propagating through the functional portion 56 of the waveguide 52.

The signal output of a phase modulator of the type illustrated in FIG. 10 can be represented by:

$${E}_{out} = {E}_{in} cos ( {ω}_{c} t + \frac{{v}_{m} π}{{v}_{π}} sin ( {ω}_{m} t ) )$$

where ω_{c} is the optical frequency, ωₘ is the modulation frequency, and the electric field and intensity of the signal can be represented as

I=E²

If the magnitude of the phase modulator voltage is such that vₘ=V_{π}, then the phase term will modulate between +π and −π as sin ωₘt varies from −1 to 1. Stated differently, under the condition vₘ=v_{π}, we will have a 2_{π} phase shift.

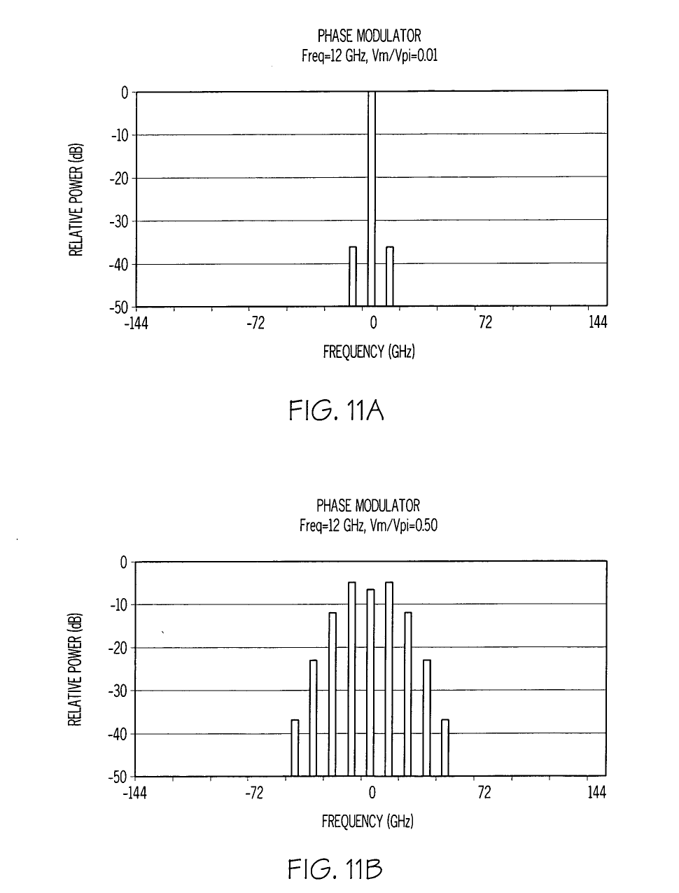

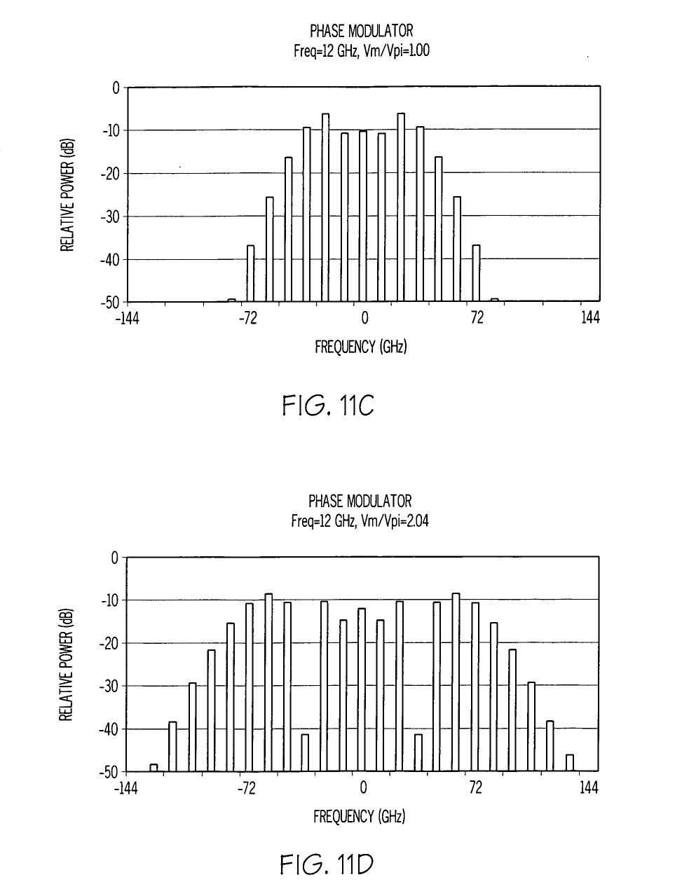

As we note above in the context of the interferometer-based sideband generator, the magnitude of the output optical signal at the fundamental frequency and at each of the odd harmonics (i.e. 3ωₘ, 5ωₘ, . . . ) can be calculated using Bessel functions. FIGS. 11A-11D illustrate the relative magnitudes of the fundamental and odd harmonics at the output of a phase modulator sideband generator 20 according to the present invention with Vₘ=0.01Vπ, Vₘ=0.50Vπ, Vₘ=Vπ, and Vₘ=2.4Vπ. As is the case for the interferometer-based sideband generator 20, the magnitude of the fifth-order harmonic for the phase modulator sideband generator 20 reaches a maximum at Vₘ=2.04Vπ.

A number of factors come into play when choosing between an interferometer-based sideband generator 20 and a phase modulator sideband generator 20. Specifically, in the case of the interferometer the output intensity varies with drive voltage and the DC bias on the interferometer can be used to adjust the output intensity signal and control the relative height of the sidebands. In contrast, when the sideband generator 20 is configured as a phase modulator, the output intensity remains relatively constant as the drive voltage is varied—only the phase of the optical signal is varied. In addition, the DC bias if the drive voltage will not affect output intensity and will not alter the height of the sidebands generated by the phase modulator. A phase modulator is as efficient at generating sidebands as an interferometer. For example, referring to FIGS. 4 and 11D, both types of sideband generators will optimize the 5th harmonic with a drive signal of about 2.04Vπ.

Interferometers can be run in a push-pull configuration and can therefore obtain a π phase shift in half the length of a single waveguide device. Phase modulators cannot be run in a push-pull condition. Accordingly, with equivalent electrooptic material, a phase modulator would have to be roughly twice as long as an interferometer. However, if an interferometer is biased at π/2, it will have a 3 dB (50%) inherent loss. In contrast, the phase modulator is not subject to this inherent loss. Accordingly, those practicing the present invention may wish to consider these factors and the optical attenuation of available electrooptic materials in choosing between interferometer-based and phase modulator type sideband generators.

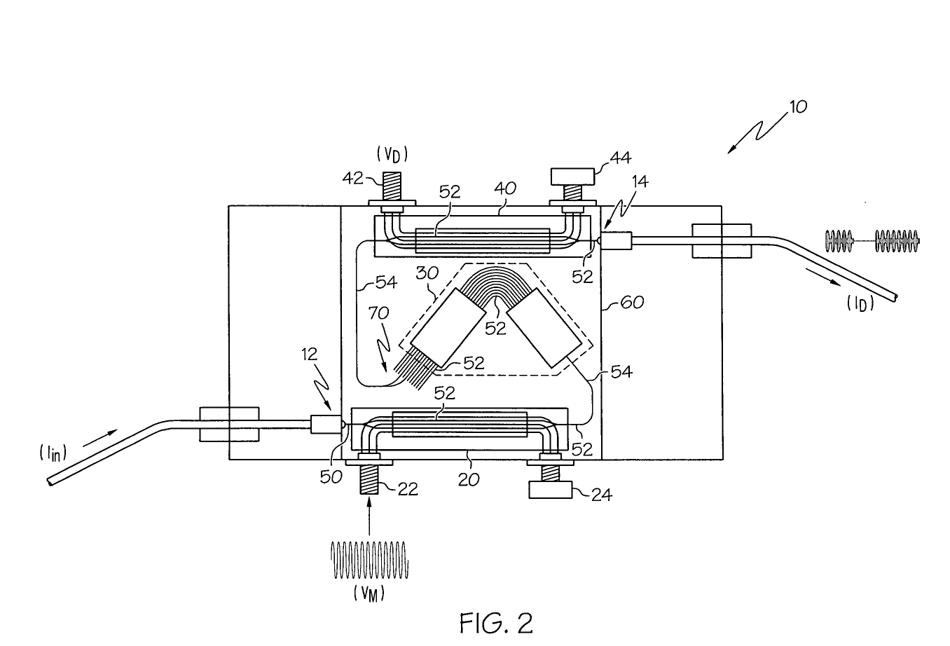

As is illustrated schematically in FIG. 2, the sideband generator 20, the optical filter 30, the data encoder 40, and the waveguide network 55, are configured such that they can be conveniently formed over a common device substrate 60. Specifically, as will be appreciated by those familiar with the optical waveguides, electrooptic modulators, and arrayed waveguide gratings described in the literature and in the U.S. patent documents incorporated by reference below, the respective functional structures of the sideband generator 20, the optical filter 30, the data encoder 40, and the waveguide network 55 are each suitable for fabrication over a common substrate 60 comprising, for example, a silica cladding layer supported by a silicon underlayer. This ability to be formed over a common device substrate holds true even where the respective structures of these devices incorporate diverse components and configurations. Accordingly, it is noted that the scope of the present invention extends to general device configurations and is not limited to the provision of a sideband generator 20 that is driven at a control voltage that is larger than Vπ.

The embodiment illustrated in FIG. 2 may also include a waveguide network 55 that comprises a substantially continuous waveguide core extending from the optical input 12 of the device 10 to the optical output 14 of the device 10. More specifically, referring to FIG. 2 in further detail, the waveguide network 55 may comprise operational waveguide portions 52 and transitional waveguide portions 54. The operational waveguide portions would be defined in the sideband generator 20, the optical filter 30, and the data encoder 40 while the transitional waveguide portions 54 would be configured to direct an optical signal between the optical input 12, the sideband generator 20, the optical filter 30, the data encoder 40, and the optical output 14 of the optical device 10. Given these portions it is contemplated that the operational and the transitional waveguide portions 52, 54 can be comprised of a common optical transmission medium that is present over at least a majority of the respective optical path lengths defined by the operational and transitional waveguide portions 52, 54. Further, the operational and transitional waveguide portions 52, 54 can be configured to define a substantially planar lightwave circuit.

The waveguide medium of the waveguide network may comprise a silica-based waveguide formed over a silica cladding layer while the waveguide medium of the sideband generator may comprise a waveguide core surrounded by or embedded within a polymeric electrooptic cladding medium. Nevertheless, the distinct components lend themselves to formation over a common substrate, often in the nature of a planar lightwave circuit (PLC). For the purposes of defining and describing the present invention, it is noted that the term “over” contemplates the presence of intervening layers between two layers or regions. For example, a waveguide medium formed over a silicon substrate contemplates the possibility of intervening layers between the waveguide medium and the silicon substrate. The specific composition of the optical transmission medium forming the waveguide core is not a point of emphasis in many embodiments of the present invention and may, for example, be selected from materials comprising doped or undoped silica, doped or un-doped silicon, silicon-oxynitride, polymers, and combinations thereof.

For the purposes of describing and defining the present invention, it is noted that a planar lightwave circuit (PLC) typically merely defines an optical input, an optical output, and points of propagation there between that lie in a substantially common plane or are formed over a substantially planar circuit component. Use of the word “circuit” herein is not intended to create an inference that an optical signal propagating in a PLC returns to its point of origin.

A variety of configurations may be utilized to form the electrooptic modulators of the present invention. For example, and not by way of limitation, the functional regions of the electrooptic modulators may comprise: electrooptically clad silica waveguides; silicon waveguides with electroabsorptive modulators where charge injected into the silicon waveguide makes the waveguide opaque; sol-gel waveguides with electrooptic claddings; lithium niobate waveguides, where the refractive index of the waveguide is dependent upon an applied electric field; and electrooptic polymer waveguides. For example, and not by way of limitation, where the electrooptic modulator comprises a waveguide core and an optically functional cladding region optically coupled to the waveguide core, the optically functional cladding region may comprise a poled or un-poled electrooptic polymer dominated by the Pockels Effect, the Kerr Effect, or some other electrooptic effect.

For the purposes of describing and defining the present invention, it is noted that an electrooptic functional region is a region of an optical waveguide structure where application of an electrical control signal to the region alters the characteristics of an optical signal propagating along an optical axis defined in the waveguide structure to a significantly greater extent than in non-electrooptic regions of the structure. For example, electrooptic functional regions according to the present invention may comprise an electrooptic polymer configured to define an index of refraction that varies under application of a suitable electric field generated by control electrodes. Such a polymer may comprise a poled or un-poled electrooptic polymer dominated by the Pockels Effect, the Kerr Effect, or some other electrooptic effect. These effects and the various structures and materials suitable for their creation and use are described in detail in the context of waveguide devices in the following published and issued patent documents, the disclosures of which are incorporated herein by reference: U.S. Pat. No. 6,931,164 for Waveguide Devices Incorporating Kerr-Based and Other Similar Optically Functional Mediums, U.S. Pat. No. 6,610,219 for Functional Materials for use in Optical Systems, U.S. Pat. No. 6,687,425 for Waveguides and Devices Incorporating Optically Functional Cladding Regions, and U.S. Pat. No. 6,853,758 for Scheme for Controlling Polarization in Waveguides; and U.S. PG Pub. Nos. 2005/0226547 A1 for Electrooptic Modulator Employing DC Coupled Electrodes, 2004/0184694 A1 for Electrooptic Modulators and Waveguide Devices Incorporating the Same, and 2004/0131303 A1 for Embedded Electrode Integrated Optical Devices and Methods of Fabrication. Further, it is noted that, various teachings regarding materials and structures suitable for generating the Pockels Effect, the Kerr Effect, and other electrooptic effects in an optical waveguide structure are represented in the patent literature as a whole, particularly those patent documents in the waveguide art assigned to Optimer Photonics Inc. or naming Richard W. Ridgway, Steven M. Risser; Vincent McGinniss, and/or David W. Nippa as inventors.

For the purposes of defining and describing the present invention, it is noted that the wavelength of “light” or an “optical signal” is not limited to any particular wavelength or portion of the electromagnetic spectrum. Rather, “light” and “optical signals,” which terms are used interchangeably throughout the present specification and are not intended to cover distinct sets of subject matter, are defined herein to cover any wavelength of electromagnetic radiation capable of propagating in an optical waveguide. For example, light or optical signals in the visible and infrared portions of the electromagnetic spectrum are both capable of propagating in an optical waveguide. An optical waveguide may comprise any suitable signal propagating structure. Examples of optical waveguides include, but are not limited to, optical fibers, slab waveguides, and thin-films used, for example, in integrated optical circuits.

For the purposes of defining and describing the present invention, it is noted that a Mach-Zehnder interferometer structure generally comprises an optical configuration where an optical signal propagating along a waveguide is split into a pair of waveguide arms and recombined into a single waveguide following treatment of the respective optical signals propagating in one or both of the waveguide arms. For example, the signal in one of said waveguide arms may be treated such that the optical signal propagating therein is subject to a given phase delay. As a result, when the signals of the respective waveguide arms are recombined, they interfere and generate an output signal indicative of the interference. A number of Mach-Zehnder interferometer structures are illustrated in detail in the above-noted patent documents.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention. For example, although electrooptic functional regions according to specific embodiments of the present invention can be selected such that the variation of the index of refraction is dominated by an electrooptic response resulting from the Kerr Effect because Kerr Effect mediums can, in specific configurations, have the capacity for significantly higher changes in index of refraction than mediums dominated by the Pockels Effect, it is understood that electrooptic region may be dominated by the Pockels Effect, the Kerr Effect, or some other electrooptic effect.

What is claimed is:

1. An optical device comprising a waveguide network, a sideband generator, and an optical filter, wherein:
said waveguide network is configured to direct an optical signal from an optical input of said optical device through said sideband generator and said optical filter to an optical output of said optical device;
said sideband generator comprises an electrooptic interferometer comprising first and second waveguide arms and a modulation controller configured to drive said sideband generator at a control voltage substantially larger than V_{π} to generate frequency sidebands about a carrier frequency of said optical signal, where V_{π} represents the voltage at which a π phase shift is induced between respective arms of said interferometer; and
said optical filter is configured to discriminate between said frequency sidebands and said carrier frequency such that sidebands of interest can be directed to said optical output.

2. An optical device as claimed in claim 1 wherein said sideband generator is configured such that said carrier frequency of said optical signal is dominated by odd or even harmonic frequency sidebands of said carrier frequency at an output of said sideband generator.

3. An optical device as claimed in claim 2 wherein said odd or even harmonic frequency sidebands comprise third or higher order odd or even harmonic frequency sidebands of said carrier frequency.

4. An optical device as claimed in claim 1 wherein:
said sideband generator is configured such that said carrier frequency of said optical signal is dominated by odd or even third or greater order harmonic frequency sidebands of said carrier frequency at an output of said sideband generator; and
said control signal approximates a sinusoidal voltage where an amplitude of said third or greater order sidebands reaches a maximum.

5. An optical device as claimed in claim 1 wherein:
said sideband generator is configured as an electrooptic interferometer comprising first and second waveguide arms; and
said sideband generator comprises a modulation controller configured to drive said sideband generator at a control voltage of at least about 2V_{π}, where V_{π} represents the voltage at which a π phase shift is induced between respective arms of said interferometer.

6. An optical device comprising a waveguide network, a sideband generator, and an optical filter, wherein:
said waveguide network is configured to direct an optical signal from an optical input of said optical device through said sideband generator and said optical filter to an optical output of said optical device;
said sideband generator comprises a phase modulator comprising an optical waveguide and a modulation controller configured to drive said sideband generator at a control voltage substantially larger than V_{π} to generate frequency sidebands about a carrier frequency of said optical signal, where V_{π} represents the voltage at which a π phase shift is induced in said optical waveguide; and
said optical filter is configured to discriminate between said frequency sidebands and said carrier frequency such that sidebands of interest can be directed to said optical output.

7. An optical device comprising a waveguide network, a sideband generator, and an optical filter, wherein:
said waveguide network is formed over a device substrate and is configured to direct an optical signal from an optical input of said optical device through said sideband generator and said optical filter to an optical output of said optical device;
said sideband generator is formed over said device substrate and is configured to generate frequency sidebands about a carrier frequency of said optical signal; and
said optical filter is formed over said device substrate and is configured to discriminate between said frequency sidebands and said carrier frequency such that sidebands of interest can be directed to said optical output.

8. An optical device as claimed in claim 7 wherein:
said sideband generator is configured such that said optical signal is dominated by odd or even harmonic frequency sidebands of said carrier frequency at an output of said sideband generator; and
said odd or even harmonic frequency sidebands comprise third or higher order harmonic frequency sidebands of said carrier frequency.

9. An optical device as claimed in claim 8 wherein said optical filter is configured to pass an odd or even harmonic of said third or higher order and block substantially all of a remaining portion of said optical signal.

10. An optical device as claimed in claim 7 wherein a channel spacing defined by said frequency sidebands of interest is at least about 100 GHz.

11. An optical device as claimed in claim 7 wherein said sideband generator is configured such that a magnitude of said frequency sidebands of interest, at an output of said sideband generator, is at least about 10% of a magnitude of said optical carrier signal at said optical input of said optical device.

12. An optical device as claimed in claim 11 wherein said frequency sidebands of interest comprise third or greater order harmonic frequency sidebands of said carrier frequency.

13. An optical device as claimed in claim 7 wherein:
said sideband generator is configured as an electrooptic interferometer comprising first and second waveguide arms; and
said sideband generator comprises a modulation controller configured to drive said sideband generator at a control voltage substantially larger than V_{π}, where V_{π} represents the voltage at which a π phase shift is induced between respective arms of said interferometer.

14. An optical device as claimed in claim 13 wherein:
said sideband generator is configured such that said optical signal is dominated by odd or even harmonic frequency sidebands of said carrier frequency at an output of said sideband generator; and
said control signal approximates a sinusoidal voltage where an amplitude of said third or greater order sidebands reaches a maximum.

15. An optical device as claimed in claim 7 wherein:
said sideband generator is configured as an electrooptic interferometer comprising first and second waveguide arms; and
said sideband generator comprises a modulation controller configured to drive said sideband generator at a control voltage of at least about 2V_{π}, where V_{π} represents the voltage at which a π phase shift is induced between respective arms of said interferometer.

16. An optical device as claimed in claim 15 wherein:
said sideband generator is configured such that said optical signal is dominated by odd or even, third or greater order harmonic frequency sidebands of said carrier frequency at an output of said sideband generator; and
said control signal approximates a sinusoidal voltage where an amplitude of said third or greater order sidebands reaches a maximum.

17. An optical device as claimed in claim 7 wherein:
said sideband generator is configured as a phase modulator; and
said sideband generator comprises a modulation controller configured to drive said sideband generator at a control voltage substantially larger than V_{π}, where V_{π} represents the voltage at which a π phase shift is induced in said phase modulator.

18. An optical device as claimed in claim 7 wherein:
said optical filter comprises an arrayed waveguide grating comprising wavelength channels corresponding to said sidebands of interest;
said wavelength channels corresponding to said sidebands of interest are coupled to an optical signal combiner.

19. An optical device as claimed in claim 7 wherein said waveguide network comprises a substantially continuous waveguide core extending from said optical input of said device to said optical output of said device.

20. An optical device as claimed in claim 7 wherein:
said waveguide network comprises operational waveguide portions defined in said sideband generator and said optical filter;
said waveguide network comprises transitional waveguide portions configured to direct an optical signal between said optical input, said sideband generator, said optical filter, and said optical output of said optical device; and
said operational and said transitional waveguide portions are comprised of a common optical transmission medium that is present over at least a majority of the respective optical path lengths defined by said operational and transitional waveguide portions.

21. An optical device as claimed in claim 7 wherein:
said waveguide network comprises operational waveguide portions defined in said sideband generator and said optical filter;
said waveguide network comprises transitional waveguide portions configured to direct an optical signal between said optical input, said sideband generator, said optical filter, and said optical output of said optical device; and
said operational and said transitional waveguide portions define a substantially planar lightwave circuit.

22. An optical device as claimed in claim 7 wherein said optical device further comprises a data encoder formed over said device substrate and configured to generate an encoded optical data signal from said frequency sidebands of interest.

23. An optical device as claimed in claim 7 wherein said optical device further comprises a data encoder configured to generate an encoded optical data signal from an optical signal directed from said optical filter including said frequency sidebands of interest.

24. An optical device as claimed in claim 23 wherein said data encoder comprises an electrooptic modulator configured to modulate said optical signal directed from said optical filter.

25. An optical device as claimed in claim 24 wherein said electrooptic modulator defines an interferometer configuration.
